(19) United States
(12) Patent Application Publication
(10) Pub. No.: US 2010/0030779 A1
(43) Pub. Date: Feb. 4, 2010

(54) SYSTEM AND METHOD FOR IDENTIFYING AND LINKING USERS HAVING MATCHING CONFIDENTIAL INFORMATION

(75) Inventor: Tien Hin Winston Tan, Singapore (SG)

Correspondence Address: CONLEY ROSE, P.C.;David A. Rose, P. O. BOX 3267, HOUSTON, TX, 77253-3267, US

(73) Assignee: WINMARK INVESTMENTS PTE. LTD.

(21) Appl. No.: 12/444,663

(22) PCT Filed: Oct. 9, 2006
(86) PCT No.: PCT/SG06/00303

§ 371 Date: Aug. 17, 2009

(51) Int. Cl. G06F 7/10; G06F 17/30

(52) U.S. Cl. 707/6; 707/E17.108; 707/3

(57) ABSTRACT

A system and method for identifying and linking users having matching confidential information, the system comprising: a database for storing user information in a manner such that one or more data fields representing at least a portion of the user information are associated with respective confidentiality levels; a matching engine for identifying matching information in the data fields; and a linking unit for linking two or more users associated with matching information identified by the matching engine.

### FIELD OF INVENTION

The present invention relates to a system and method for identifying and linking users having matching confidential information.

### BACKGROUND

In the Internet, there are many websites for linking individual to individual, individual to services, individual to products and to provide information and search capabilities for information on the individual, services and products. Many of these websites do not have protection for their subscribers from fake identities, cheats and swindlers. This affects true identities, genuine services and products, as they may also be deemed as untrustworthy.

As such, people are afraid to reveal confidential information and withhold information to protect their own interests. With limited or wrong information, it is inherently difficult to find a good match to what an individual is looking for, and similarly it is thus difficult, if not impossible to recommend good choices and advertise to the individual what is needed at the right time. Indeed, many times people end up not getting what they truly require from such websites.

While there are also many trusted websites around, these trusted websites are dedicated to provide to a niche market only and do not have the capability to provide services, products and to link individuals at a global level and to tap into other genuine resources.

Furthermore, though many websites are available to link individuals, there appears to be few or no websites with comprehensive facilities catering to or linking corporation to corporation, corporation to services, corporation to products and to provide information and search capabilities for information on the corporation, services and products.

Furthermore, existing website fail to capture the “natural” flow of transactions between persons, either as individuals or as representatives of companies, organisations etc., in particular when those transactions relate to confidential information. As a result, for many scenarios, existing websites have not managed to replace or enhance the conventional person-to-person transactions and negotiations.

A need therefore exists to provide a system and method for identifying and linking users having matching confidential information that addresses at least one of the above-mentioned problems.

### SUMMARY

In accordance with one aspect of the present invention, there is provided a system for identifying and linking users having matching confidential information, the system comprising: a database for storing user information in a manner such that one or more data fields representing at least a portion of the user information are associated with respective confidentiality levels; a matching engine for identifying matching information in the data fields; and a linking unit for linking two or more users associated with matching information identified by the matching engine.

The linking unit may alert the users associated with the matching information by sending electronic messages to the users.

The system may further comprise a communication platform for facilitating negotiation between the users.

The communication platform may comprise one or more of a group consisting of:
an email server;
a messaging application;
an Internet telephony application; and
a video conferencing application.

The database may further store data representing reference information for users.

The system may further comprise a referencing platform for displaying reference information of one user associated with the matching information to another user associated with the matching information.

The reference platform may provide links to other reference information associated with the reference information displayed for establishing a chain of references for authenticating trustworthiness of the respective users.

The other reference information may comprise reference information stored in the database of the system, reference information stored at an external source, or both.

The system may further comprise a search platform for user input of search criteria, and the search platform is coupled to the matching engine for identifying information in the data fields matching the search criteria.

In accordance with another aspect of the present invention, there is provided a method for identifying and linking users having matching confidential information, the method comprising: storing user information in a database in a manner such that one or more data fields representing at least a portion of user information are associated with respective confidentiality levels; identifying matching information in the data fields utilising a matching engine; and linking two or more users associated with matching information identified utilising a linking unit.

The method may further comprise alerting the users associated with the matching information by utilising the linking unit to send electronic messages to the users.

The method may further comprise facilitating negotiation between the users utilising a communication platform.

The communication platform may comprise one or more of a group consisting of:
an email server;
a messaging application;
an Internet telephony application; and
a video conferencing application.

The method may further comprise storing data representing reference information for users in the database.

The method may further comprise displaying reference information of one user associated with the matching information to another user associated with the matching information utilising a reference platform.

The method may further comprise establishing a chain of references linking to other reference information associated with the reference information displayed for authenticating trustworthiness of the respective users utilising the reference platform.

The other reference information may comprise reference information stored in the database of the system, reference information stored at external sources, or both.

The method may further comprise inputting search criteria; and identifying information in the data fields matching the search criteria utilising the matching engine.

In accordance with yet another aspect of the present invention, there is provided a data storage device containing computer readable code means for instructing a computer system to execute a method for identifying and linking users having matching confidential information, the method comprising: storing user information in a database in a manner such that one or more data fields representing at least a portion of user information are associated with respective confidentiality levels; identifying matching information in the data fields utilising a matching engine; and linking two or more users associated with matching information identified utilising a linking unit.

### BRIEF DESCRIPTION OF THE DRAWINGS

Embodiments of the invention will be better understood and readily apparent to one of ordinary skill in the art from the following written description, by way of examples only and in conjunction with the drawings, in which:

FIG. 1 shows the system architecture of an example embodiment of the present invention.

FIG. 2 is a flowchart of the method according to an example embodiment of the present invention.

FIG. 3 illustrates two end users communicating according to an example embodiment of the present invention.

FIG. 4 is a web user interface according to an example embodiment of the present invention.

FIG. 5 illustrates a web user interface having cascading referencing windows according to an example embodiment of the present invention.

FIG. 6 illustrates a schematic drawing of a computer system for implementing the Intelligent Matching System according to the example embodiment.

### DETAILED DESCRIPTION

The described embodiments provide an intelligent matching system and method which replicate or enhance the real life process of persons wanting to transact with each other, in particular wanting to transact with each other for exchange of products, services, or information.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilising terms such as “searching”, “matching”, “linking”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatuses for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

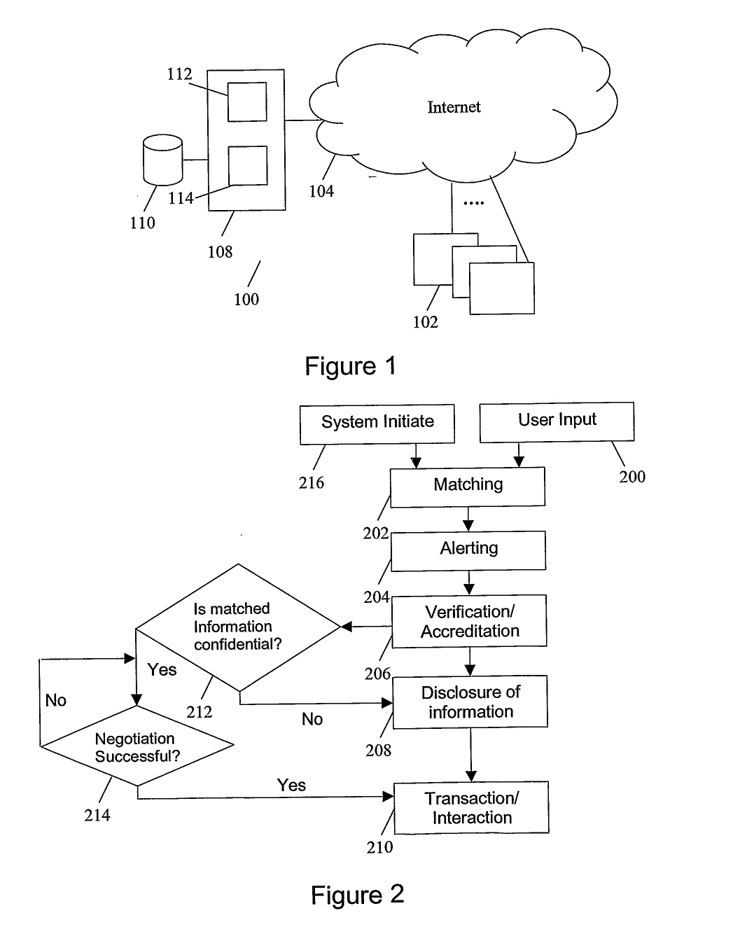

FIG. 1 shows the system architecture 100 of an example embodiment of the present invention.

An Intelligent Matching System (IMS) 108 is connected to the Internet 104. The IMS 108 hosts a website which remote user computers 102 can access via the Internet. It is appreciated that the computer 102 may be a desktop computer, a server or a mobile device such as a personal digital assistant (PDA), a laptop computer, a mobile phone or the like. The IMS 108 provides intelligent matching services to end users on their computers 102. The IMS 108 stores all data representing products, services, or information posted or entered by end users on the website as data fields in a database 110. References in the present patent specification to saving or storing information in or at the IMS are understood to be information saved or stored at the database 110. Further, references in the present patent specification to clickable links, hyperlinks or the like are understood to be clickable through the use of an electronic mouse pointer on a computer display.

In the example embodiment, users wanting to use the intelligent matching services provided by the IMS 108 open an online account through the website. Subsequently, users login to the IMS 108 by entering the right username and password to gain access to their user account with the IMS 108.

After opening an account with the IMS 108, users are able to post information on the website from the computer 102 via the website user interface. Information to be posted is sent to the IMS 108 for storage in the database 110. The IMS 108 posts the information on the website according to the user settings, which the user sets through the website user interface. All user settings and information posted or entered are stored at the database 110 by the IMS 108. In the example embodiment, users may refer to States and all types of government or private corporate organizations and not just restricted to individuals. Each account entitles the user to a limited amount of data storage space in the database for storing information posted by the user.

In the example embodiment, after a user logs into its account, the user is led to a main menu webpage. By clicking on a hyperlink in the main menu webpage, the user calls out a user settings webpage. The purpose of the user settings webpage is for the user to make preferred settings on the features and services available to its account on the IMS 108. For instance, to select, disable or enable a particular feature or service available on IMS 108, the user checks or unchecks a checkbox in the user settings webpage. In the example embodiment, user setting options are 1) type of classification system used for classifying information, 2) IMS 108 recommended classification system, 3) most popular classification system, 4) type of search/matching engine 112 used by IMS 108 to perform searching/matching, 5) use of an information matching percentage (details provided below) and 6) use of IMS automatic matching function (details provided below). An example of an information search/matching engine 112 used by the IMS 108 is the IBC Engine by IBC Systems. An example of an information classification system used by the IMS 108 is the Acyclic Graph Classification System by Elysium.

In the example embodiment, information is categorized or classified into different categories and subcategories. Each category and sub-category of information has many associated attributes and the information is advantageously classified into a plurality of confidentiality levels or state of confidence, from the most confidential information e.g. level 5 to the least confidential information e.g. level 0. Level 0 information is information users wish to make available to the world at large. Information at other levels is not to be disclosed to any one unless the user makes the setting to allow the information under the specific category and confidentiality level to be disclosed.

Advantageously, users have full control over the categorization and confidentiality setting of the information they post. For the convenience of users, the IMS 108 contains a list of predefined categories, sub-categories, attributes of the categories/sub-categories and confidentiality settings where users can choose to use and apply.

Examples of pre-defined categories, sub-categories and attributes of information and the accompanying confidentiality levels set by the IMS 108 are as follow.

Example of information that is entered by a job seeker:
Category: People
   Sub-category: Occupation
   Sub-category: Field
   Sub-category: Information Technology
      Sub-category: Job Openings—Sub-category of Occupation: Software Engineer
         Attributes of Software Engineer:
            Level 0: Name
            Level 1: qualifications, awards
            Level 2: past working experience, character
            Level 3: values, interests
            Level 4: friends, relatives
            Level 5: Medical History, ideal working requirements, ideal pay

Example of information that is entered by a corporation wanting to employ a software engineer:
Category: Corporation
   Sub-category: Type of business
   Sub-category: Information Technology
   Sub-category: Job Openings
      Sub-category of Job openings: Software Engineer
         Attributes of Software Engineer:
            Level 0: qualifications, awards, character, job scope
            Level 1: values, interests
            Level 2: preferred company previously worked for
            Level 3: Ideal pay

Example of information that is entered by a person wanting to buy a particular type of handbag:
Category: Product
   Sub-category: Buying products
   Sub-category: Handbag
      Attributes of Handbag:
         Level 0: dimensions, strap type, design
         Level 1: quality assurance, colour, brand, reviews
         Level 2: who owns one, who reviewed
         Level 4: price

Example of information that is entered by a person wanting to sell a particular type of handbag:
Category: Product
   Sub-category: Selling products
   Sub-category: Handbag
      Attributes of Handbag:
         Level 0: dimensions, strap type, design, user reviews
         Level 1: quality assurance, colour, brand
         Level 2: who owns one
         Level 4: price

Example of information that is entered by a corporation offering a particular type of Laundry Service:
Category: Service
   Sub-category: Service Offered
   Sub-category: Laundry service
      Attributes of Laundry service:
         Level 0: time to deliver, benefits of service, company name
         Level 1: methodology, costs, depth of service
         Level 2: quality, past customers
         Level 4: reviews
         Level 5: company financials

Example of information that is entered by a person seeking a particular type of Laundry Service:
Category: Service
   Sub-category: Service Sought
   Sub-category: Laundry service
      Attributes of Laundry service:
         Level 0: time to deliver, benefits of service, company name
         Level 1: methodology, costs, depth of service
         Level 2: quality, past customers
         Level 4: reviews
         Level 5: company financials

Information posted by users in all confidentiality levels is accessible by the IMS 108. In the example embodiment, if a user checks the checkbox for enabling the IMS automatic matching function, the IMS 108 is set to automatically search and match information of all user posted information in all confidentiality levels stored in the database 110 including information available in external Internet sources. For instance, if a first user posts a piece of information in its account and a second user have already posted or at a later stage posts a piece of information in its account that matches the piece of information posted by the first user, the IMS 108 automatically informs the user of a match.

In the example embodiment, the matching process performed by the IMS 108 is based on the category, sub-category and attributes. For instance, in a first step, the IMS 108 proceeds to match the categories classified by the first user and second user. Once a match in words, text or numbers is found in the categories, the IMS 108 proceeds to match the words, text or numbers in the sub-categories classified by the first user and second user in a second step. Once a match in words is found in the sub-categories, the IMS 108 proceeds to match the words used to describe the attributes entered by the first user and second user in a third step. It is appreciated that the matching of words is not restricted to matching word for word e.g. a category named ‘People’ in the first user account is matched to the same category named ‘People’ in the second user account. Matching of words also involves matching related words and phrases and considers the language used by the users and their motives e.g. the sub-category of a corporation employing ‘Type of business’ is matched with the sub-category of a job seeker ‘Field’. It is also appreciated that besides text, the category, sub-categories and information in the attributes may be extended to include pictures, videos and sound clips where the IMS 108 uses the appropriate matching technologies for matching the pictures, videos and/or sound clips.

Besides the automatic matching function, the IMS 108 comprises a search platform where users can choose to use a manual search function by requesting via the website for the IMS 108 to search on any user provided keywords and phrases, i.e. search parameters, that matches the information accessible to the IMS 108. Users of the manual search function may be non-account holders, or existing account holders of the IMS 108 that need to conduct a search on certain information not already posted in their account. The search results returned may be immediate or delayed depending on the availability of the information required, the extent of the search involved and depending on the time frame for conducting the search so set by the user to capture the latest information being released, i.e. being released from confidentiality or being published in external Internet sources. The search parameters used by the user may be saved by the IMS 108, be given or be set with a confidentiality level, and made searchable by the IMS 108. It is appreciated that besides text, search parameters may be extended to include pictures, videos and sound clips where the IMS 108 uses the appropriate matching technologies for the pictures, videos and/or sound clips.

In both the automatic matching function and the manual search function, if a match occurs, a linking unit 114 of the IMS 108 will alert the user through online messaging applications (e.g. a chat program), pop up messages/advertisements, emails, Short Messaging Service (SMS), Multimedia Messaging Service (MMS) or the like. It is appreciated that an email server is connected to the IMS 108 for controlling the sending and receiving of emails.

If a match is found in external Internet sources and if the information is already available to the public domain, the IMS 108 will return a webpage containing the information to the user initiating the search or the user who has posted information in the case of automatic matching function in operation.

If the information is not available to the public domain or requires registration, payment to access or authorization to access, the IMS 108 will return a webpage linked to the external trusted Internet source for registration, payment or authorization to the user.

If a match in the keywords or phrase is found in another user account at a particular category and confidentiality level, the confidential information relating to the match will be returned only if the other user has allowed access to the confidential information. If the other user disallows access to the confidential information, the IMS 108 will return a webpage at least showing information relating to the credibility of the other user (as much as the other user allowed revealing), brief description of the confidential information containing the matched information that is yet to be revealed and its level of confidentiality, and having at least the options for further negotiation to reveal confidential information, payment sought for accessing information (if so required), registration for accessing information (if so require), or authorization means to gain access to the confidential information (if so require) to the user seeking the information. An example of authorization means would be entering the authorized username and password to gain access.

Where there are multiple matches or hits, the IMS 108 will return in a webpage a list of the matching candidates and their links to the web pages mentioned in the above scenarios to the user initiating the search. The IMS 108 has the ability to sort the list of matching candidates in the order of most trustworthy and most relevant to the search parameters or user entered information in the case of automatic matching function in operation to the least relevant to the search parameters or user entered information and least trustworthy. Relevancy of information is gauged based on the information matching percentage. For example, a word for word match is 100%. Details on determination of trustworthiness are described below.

In case the user does not get any search/matching results for a search or automatic matching by IMS 108 due to over demanding criteria or search parameters, mechanisms are provided by the IMS 108 for the user to lower the information matching percentage so that less relevant search/matching results fulfilling some but not all the criteria will appear.

Negotiation to reveal confidential information may be carried out through the web platform of the IMS 108. In the example embodiment, this can be achieved through communication means such as a built-in messaging and/or email application on the web platform of the IMS 108, where messages and/or emails only for the attention of the other user can be sent. The history of the messages and emails may be stored by the IMS 108 into the database 110 and be made searchable. Similar to confidential information posted by any user, the parties involved in the negotiation can categorize the contents of the messages and emails and set the confidentiality level of the contents of the messages and emails. If a match is found in the contents of the messages and emails of the negotiation, the parties involved in the negotiation will show up as matching candidates. It is appreciated that the built-in messaging application enabling online chat may incorporate SMS and/or MMS messaging features to communicate with the parties involved via a mobile telecommunication network.

It is appreciated that the exchanges in the emails and messaging interfaces in a negotiation can be offline where each party checks each other's emails or messages at their own convenience, or in real time if both parties are logged in to the IMS 108 at the same time.

It is appreciated that besides email and messages, the IMS 108 can provide other communication means for online meeting between the parties through Internet telephony or video conferencing in a negotiation.

Such negotiations to reveal information may lead to a transaction or interaction taking place between the parties. Examples of transactions and interactions are the purchase and sale of items, employment of staff, engaging certain services, and establishing personal relationships. If involving more than one party, transactions and interactions can also mean hosting an online private auction with selected users allowed to view information relating to the auction, attending an online seminar/meeting/lecture or the like. The IMS 108 provides the appropriate user interface to aid the carrying out of such transactions. For example, providing electronic payment means for purchase and sale of items, providing electronic file transfer means, provide means for setting up blogs or information disclosure platforms, and providing video conferencing, text/voice messaging and email means for establishing personal relationship and for communication between the relevant parties. It is appreciated that each piece of information disclosed can be set by the user to be accessible only to selected users and the extent of information revealed can vary for each selected user.

The IMS 108 determines whether negotiation is successful based on whether the users reveal their confidential information in higher confidentiality levels and whether the users have initiated for a transaction or interaction to take place. Successes can be logged and success rates of users in negotiation can be calculated for use in, for example, assigning a trustworthiness rating, indicate ease of doing business etc.

Besides posting information about one's desires and preferences, users can post information such as accolades, accreditations, credentials and referrals to establish their credibility to other users. Based on the posting of such information and the user setting on how much to reveal, the IMS 108 reveals information relating to the user's credibility to other users accordingly. This advantageously establishes trust between users.

To further establish trust in case the accolades, accreditations, credentials and referrals are unfamiliar to the user seeking information on another user, in the IMS 108, clickable references or links to the accolades, accreditations, credentials and referrals of users are provided (subject to the users permission to reveal) in the website to open up windows of web pages relating to the accolades, accreditations, credentials and referrals. The links of the accolades, accreditations, credentials and referrals may be web pages of other user accounts or web pages of external Internet sources, which in turn contains more links to accolades, accreditations, credentials and referrals. This chain of referencing and opening of cascading webpages will carry on as the user seeking information continues to open up more links until the user finds the accolades, accreditations, credentials and referrals that it is familiar with and comfortable for the user to trust the unknown user and unknown user's revealed information. This process effectively accredits unknown users to other users.

To ensure the search results returned are genuine, the IMS 108 advantageously provides options for users to select through the website to return only matched information that has been authenticated by recognized and reputable external parties or recognized and reputable users having an account with the IMS 108 such as politicians, banks, universities and institutions etc. In this regard, the IMS 108 also provides options for users to authenticate the truth of other user's information and statuses.

To provide further proof for user integrity and user information, the IMS 108 includes online features for users to execute online or to request for execution and the publication of scanned original copies of statutory declaration, affidavits, certified documents, notarized documents, legalized documents or other legal tools, which are authenticated by authorized and trustworthy personnel or organizations. This can be done at the time the user opens an account with IMS 108.

The IMS 108 can advantageously make use of the number of successful transactions, the number of authentications by reputed parties or users of the IMS 108 to genuine information posted by a user and the user's integrity, the search parameters used by users, the information posted by users and stored by the IMS 108 in the database 110, and the negotiation contents, to determine what exactly a user requires and automatically recommend a link up i.e. if the automatic matching function is enabled to trusted online resources or other recognized users, advertise genuine products and services based on the user's posted information on its desires, interests and preferences, and return trustworthy search/matching results to the user accordingly. Based on the above information, the IMS 108 can terminate user accounts of untrustworthy users and provide a trustworthiness rating for each user account and the posted information by the IMS 108 accordingly.

The IMS 108 employs appropriate network security technologies, such as firewalls, user authentication techniques, data encryption, anti-spyware software, anti-virus software or the like to protection the confidential information from being leaked into the Internet or retrieved by unauthorized personnel.

FIG. 2 is a flowchart of the method employed by the IMS (108 in FIG. 1).

At step 200, a user using the manual search function inputs search parameters to look for information in the IMS 108 that matches the search parameters.

Step 216 is another scenario that may cause the use of the method. In this case, a user having an account with the IMS (108 in FIG. 1) enables the automatic matching function.

At step 202, the IMS (108 in FIG. 1) performs the search and matches the search parameters or information posted on the user's desires, interests and preferences with the stored information in the database (110 in FIG. 1).

On finding a match, the IMS (108 in FIG. 1) automatically alerts the user at step 204. As mentioned previously, alerting the user can be through online messaging applications, pop up messages/advertisements, emails, Short Messaging Service (SMS), Multimedia Messaging Service (MMS) or the like.

At step 206, the user filters through the search/matching results received through the alerting means in step 204 and sorted in order of most trustworthy rating and most relevant based on the information matching percentage to least trustworthy rating and least relevant. Each search result is a link to either the matched information (if so allowed by other users to be viewed), external Internet resources or other user accounts containing the matched information. If the automatic matching function is enabled, the link to the matched information will indicate what in the user's posted information triggered the IMS to automatically find a match. Each search/matching result contains a list of accolades, accreditations, credentials and referrals as much as is disclosed by the user and a trustworthiness rating by the IMS (108 in Figure). If the user does not trust the trustworthiness rating and finds the accolades, accreditations, credentials and referrals unfamiliar, the user may go through the chain of referencing by opening cascading webpages through clicking hyperlinks until the user is satisfied that the link is trustworthy.

Next, the IMS (108 in FIG. 1) checks whether the user can access the information in the search/matching results at step 212.

If the search/matching results are not confidential and accessible to the user, disclosure of information takes place at step 208.

If the search/matching result leads to undisclosed information of other users, which is inaccessible to the user, negotiation between the user requesting for the confidential information and the user who posted the undisclosed information will take place. The IMS system then determines whether negotiation is successful at step 214 based on whether the users reveals their confidential information in higher confidentiality levels and whether the users have initiated for a transaction or interaction to take place.

If negotiation is successful, disclosure of information takes place at step 208.

If negotiation is unsuccessful, further negotiation can be initiated. The success of the negotiation is tested again at step 214.

After disclosure of information, a transaction or interaction may occur between both parties at step 210. A transaction or interaction may include, as mentioned previously, for instance, the purchase and sale of items, employment of staff, engaging certain services, and establishing personal relationships.

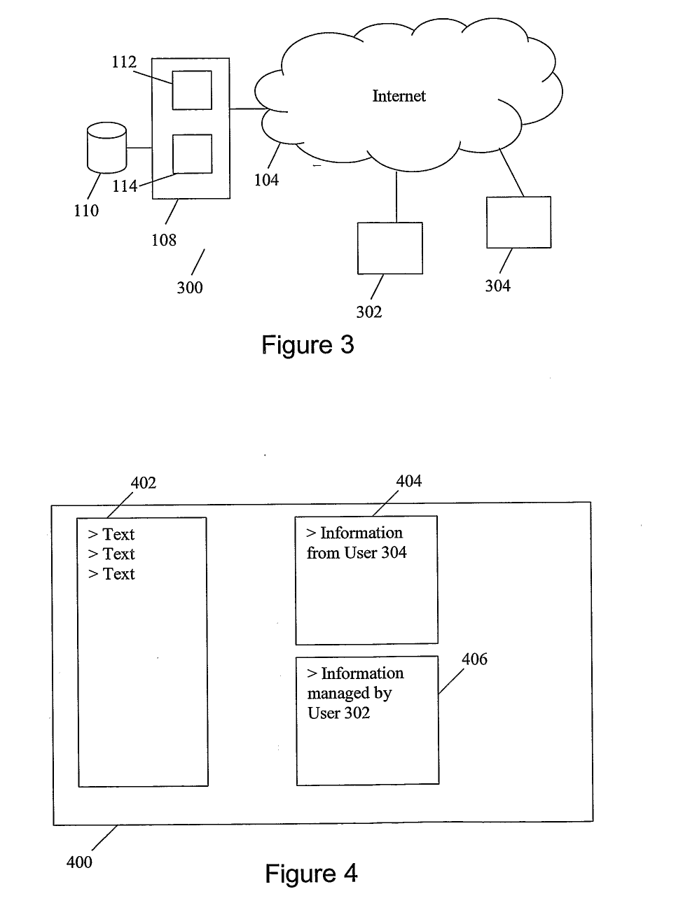

FIG. 3 illustrates two end users communicating according to an example embodiment of the present invention.

FIG. 3 shows a system architecture 300 that is similar to the system architecture (100 in FIG. 1) in FIG. 1 except that the system architecture 300 shows two users 302, 304 to each another communicating via IMS 108 after login to their respective user accounts with IMS 108.

User 302 previously entered confidential information into its account and saved them through the IMS web interface into database 110. Similarly, User 304 previously entered confidential information into its account and saved them through the IMS web interface into database 110.

User 302 has enabled the automatic matching function of the IMS 108. In this example, the information in the account of User 304 contains matched information corresponding to the confidential information previously entered by User 302.

FIG. 4 shows an example of a web user interface hosted by the IMS 108 as viewed on the computer display of user 302. It is appreciated that corresponding windows will be displayed on the computer display of User 304.

In the example embodiment, there is a computer display 400 having three windows, a negotiation window 402, a User 304 information disclosure window 404 for displaying information entered by User 304 and a User 302 information disclosure window 406 for displaying information entered by User 302.

The negotiation window 402 is part of a communication platform of the IMS that displays emails and messages revealed to users selected by User 302. In this example, User 302 selects only User 304 to see its emails and messages. It is appreciated that the negotiation window 402 may contain a list of unexpanded emails and messages, which are expandable to reveal details of the emails and messages upon clicking a corresponding hyperlink or icon (Not shown in FIG. 4).

The User 304 information disclosure window 404 displays information released for disclosure by User 304, based on selected confidentiality level(s). Additionally, a brief summary of information not yet fully released for disclosure by User 304 may be displayed, again based on selected confidentiality level(s). Matched information previously identified by the IMS may be displayed in a different colour from the normal text colour. It is appreciated that other highlighting means may be used, e.g. setting different colour background, different fonts etc.

The User 302 information disclosure window 406 provides an interface for the User 302 to manage display of its information to User 304 based on the confidentiality levels. It will be appreciated that the information released by User 302 for display to User 304 is displayed by the IMS in a corresponding User 302 information disclosure window on User 304's computer display. Matched information can again be displayed in a different colour from the normal text colour. It is appreciated that other highlighting means may be used, e.g. setting different colour background, different fonts etc.

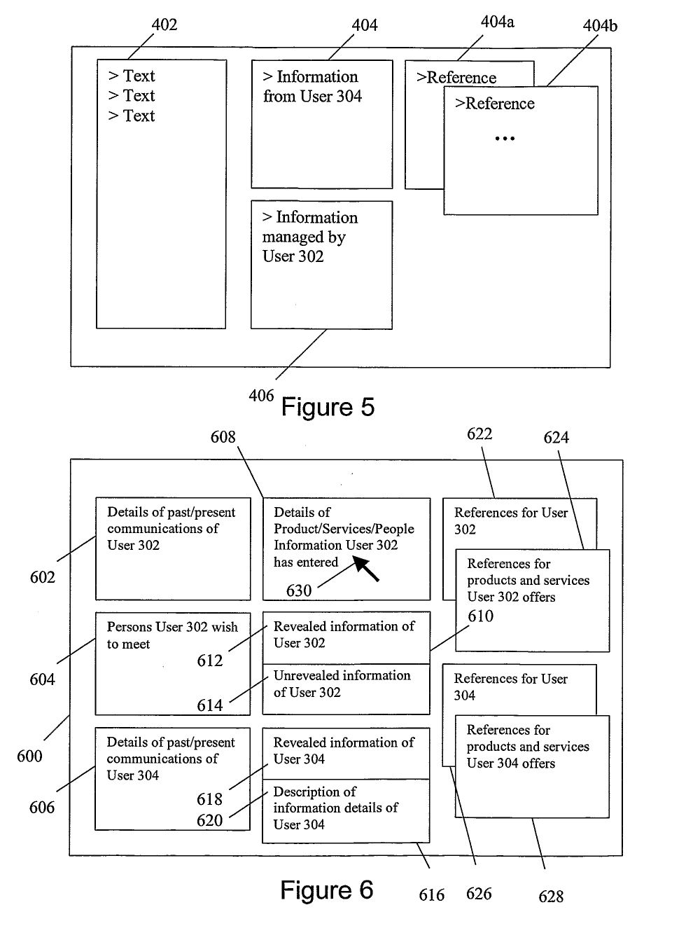

The User 304 information disclosure window 404 may display references revealed by User 304 to User 302. This IMS in the example implementation provides users with a reference platform with the ability to review a chain of references, to satisfy themselves of the trustworthiness of the other party. More particular, if the User 302 clicks on a hyperlink representing the revealed reference for User 304, further windows 404a, 404b relating to cross-references on the revealed reference such as accolades, accreditations, credentials and referrals existing in the IMS will show up to further authenticate trustworthiness, as shown in FIG. 5. The cascading windows 404a, 404b may comprise windows populated from data in the IMS or web pages from external Internet sources. User 302 may open as many windows relating to cross-references until User 302 sees a familiar reference and sufficient trust on User 304 is established, or alternatively, if the chain ends without User 302 having confirmed the trustworthiness of User 302, this may lead to User 302 terminating the negotiation with User 304.

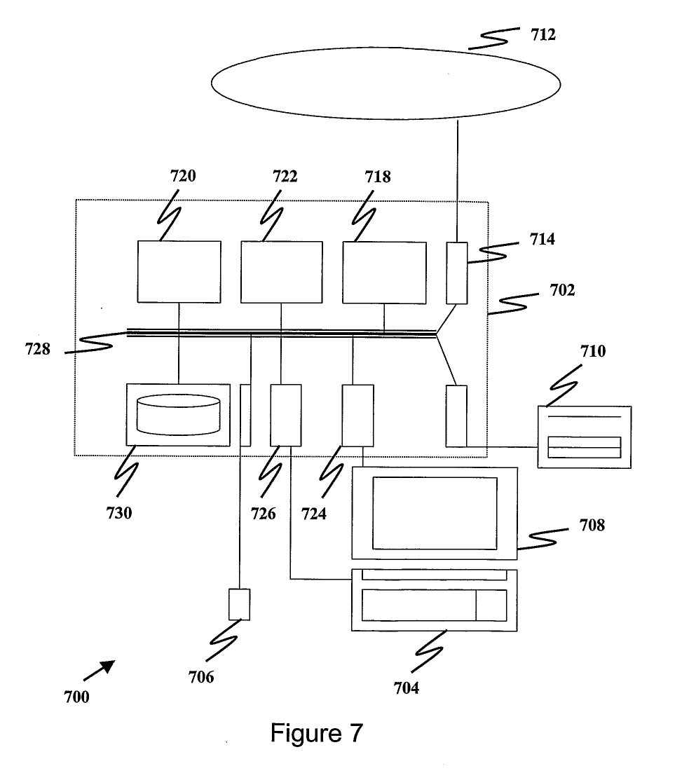

FIG. 6 shows another example of a web user interface hosted by the IMS 108 as viewed on the computer display of User 302. It is appreciated that corresponding windows will be displayed on the computer display of User 304.

In the example embodiment, there is a computer display 600 comprising ten windows, two negotiation windows 602 and 606, a personnel selection window 604, a User 302 data edit window 608, a User 302 information disclosure window 610, a User 304 information disclosure window 616, a User 302 reference window 622, a User 302 product/service reference window 624, a User 304 reference window 626 and a User 304 product/service reference window 628.

Negotiation windows 602, 606 are part of the communication platform of the IMS that displays past and present emails and/or messages of User 302 and User 304 respectively. The negotiation windows 602, 606 contain a list of unexpanded emails and messages sorted in chronological order or in other orders. The unexpanded emails and messages are expandable to reveal details of the emails and messages by clicking on the corresponding hyperlink or icon (Not shown in FIG. 6) of the unexpanded emails and messages. In the example embodiment, negotiation window 602 contains individual emails or messages, or blocks of emails or messages of past and present emails and/or messages of User 302, which User 302 has allowed User 304 to view. The negotiation window 606 contains past and present emails and/or messages belonging to User 304, which User 304 has allowed User 302 to view. Each email or message, or block of emails or messages is given a confidentiality level. User 302 reveals the email or message, or block of emails or messages to User 304 based on the selected confidentiality level(s).

The personnel selection window 604 contains a list of personnel and authorities, which User 302 previously entered into the IMS, whom User 302 wants to be linked up with. For example, the User 302 may enter or select from the interface in the personnel selection window 604 all personnel having a specific person or authority as referral, belonging to or come from a particular institution, having a particular skill/occupation/hobby/interest, living in a particular area, visited a particular website, . . . , etc. This narrows the scope of search for matching information by the IMS when the automatic matching function is enabled.

The User 302 data edit window 608 is for User 302 to add or edit information already entered and saved in the IMS. Information entered by User 302 is not restricted to any topic. For illustration purposes, information entered by User 302 may be products sold by User 302, products User 302 is seeking to purchase, services offered by User 302, services User 302 is seeking, and personal information of User 302 including preferences, desires, interests, personality, . . . , etc. In the example embodiment, each word, phrase or statement, each picture, each video recording or each voice recording of the information entered into the IMS are given a confidentiality level and this facilitates the revealing of information in a structured manner.

User 302 can add, swap, append or edit categories, sub-categories and attributes to define a structure of how he or she wishes to present certain information. It is appreciated that unclassified information can also be entered into window 608 without being classified under any category, sub-category and/or as an attribute if User 302 so desires. In the example embodiment, each attribute is a clickable hyperlink, which when clicked by a mouse pointer 630 reveals user-entered information such as text, pictures, voice recordings, video recordings, hyperlinks to information or any suitable means for representing information. Such user-entered information may be displayed in the window containing the attribute that is clicked on or in a separate window. For convenience, User 302 may use pre-determined category, sub-category and attributes provided by the IMS.

Matched information is displayed in a different colour from the normal text colour. It is appreciated that other highlighting means may be used, e.g. setting different colour background, different fonts etc. If the matched information is located in an unexpanded category, sub-category and attribute, the category, sub-category and attribute may be highlighted to indicate that the match information is classified under it.

In the example embodiment, when the User 302 data edit window 608 is opened, it displays selectable hyperlinks of unexpanded categories and/or attributes, which are pre-stored in the IMS for convenient use by users or created by User 302. The arrangement of the categories and attributes may be prearranged by the IMS or determined by the User 302. When the hyperlinks to the categories are clicked on, the category expands to reveal more attributes relating to the category, and/or unexpanded sub-categories relating to the category. The unexpanded sub-categories can be further expanded to display more unexpanded sub-categories relating to the unexpanded sub-categories, or more attributes relating to the expanded sub-category. It is appreciated that expanding a category or sub-category may mean revealing further sub-categories or attributes in the same window 608 or open up more windows containing sub-categories or attributes relating to the category or sub-categories. It is further appreciated that a sub-category may be a previously displayed sub-category if the information between the sub-categories are so linked. Each category, sub-category and attribute may be given a confidentiality level by User 302.

The User 302 information disclosure window 610 provides an interface for User 302 to manage display of information to User 304 based on confidentiality levels. In the example embodiment, the User 302 information disclosure window 610 is split into two parts. A first part 612 displays information released by User 302 for display to User 304. A second part 614 displays information, which User 302 has not revealed to User 304. Information in the first and second parts 612, 614 are arranged in the similar manner as the User 302 data edit window 608, i.e. unclassified information and unexpanded categories are first displayed and the unexpanded categories can be expanded to display sub-categories and attributes.

If the first part 612 is empty, which means no information is revealed by User 302 to User 304, the second part 614 will contain exactly the same information as the User 302 data edit window 608. During operation, if User 302 selects information in a particular category with up to a selected confidentiality level to be revealed to User 304, all the information in the particular category with confidentiality level lower than the selected confidentiality level will be displayed in the first part 612. The just revealed information will disappear from the second part 614.

Matched information in both parts 612, 614 determined by the IMS will be displayed in a different colour from the normal text colour. It is appreciated that other highlighting means may be used, e.g. setting different colour background, different fonts etc. If the matched information is located in an unexpanded category, sub-category and attribute, the category, sub-category and attribute may be highlighted to indicate that the match information is classified under it.

In the example embodiment, both User 302 and User 304 have full control over the information to be revealed and displayed to one another. However, the name or alias of User 302 and User 304 is the only information that is uncontrollable by the Users and has to be revealed for purposes of identification. The IMS can provide for the alias to be changeable so that a user may keep his or her identity anonymous.

The User 304 information disclosure window 616 displays information released to User 304 by User 302 based on selected confidentiality level(s). Additionally, a brief summary of information not yet fully released for disclosure by User 304 may be displayed, again based on selected confidentiality level(s). In the example embodiment, the User 304 information disclosure window 616 is split into two parts. A first part 618 displays information released by User 304 for display to User 302. A second part 620 displays a brief summary of information not yet fully released for disclosure by User 304. The brief summary may comprise category, sub-category or attribute headers. Information in the first and second parts 618, 620 are arranged in the similar manner as the User 302 data edit window 608, i.e. unclassified information and unexpanded categories are first displayed and the unexpanded categories can be expanded to display sub-categories and attributes.

Matched information in both parts 618, 620 determined by the IMS will be displayed in a different colour from the normal text colour. It is appreciated that other highlighting means may be used, e.g. setting different colour background, different fonts etc. Similarly, if the matched information is located in an unexpanded category, sub-category and attribute, the category, sub-category and attribute may be highlighted to indicate that the match information is classified under it.

The User 302 reference window 622, the User 302 product/service reference window 624, the User 304 reference window 626, and the User 304 product/service reference window 628, are parts of the reference platform of the IMS.

The User 302 reference window 622 contains details or a list of all the references entered by User 302 for authenticating purposes. User 302 has control over whether to reveal one or more of the references in the list to User 304 based on confidentiality level(s). In the example embodiment, each reference or a block of references are given a confidentiality level and User 302 can select the revealing of all references corresponding to a common confidentiality level to User 304. Where the references are hyperlinks, User 302 can call out a chain of cascading windows containing cross-references relating to User 302 by clicking on the hyperlinks starting from reference window 622. The information in the cascading windows may be populated from data in the IMS or web pages from external Internet sources associated with the references entered in the User 302 reference window 622 or entered by User 302.

The User 302 product/service reference window 624 contains details or a list of all the references entered by User 302 for proving the authenticity of the products and/or service User 302 possesses or is providing. Similarly, User 302 has control over whether to reveal one or more of the references in the list to User 304 based on confidentiality level(s). Similar to the User 302 reference window 622, each reference or a block of references are given a confidentiality level and User 302 can select the revealing of all references corresponding to a common confidentiality level to User 304. Where the references are hyperlinks, User 302 can call out a chain of cascading windows containing cross-references relating to the products and/or services User 302 possesses or is providing by clicking on the hyperlinks starting from reference window 622. The information in the cascading windows may be populated from data in the IMS or web pages from external Internet sources associated with the references entered in the User 302 reference window 622 or entered by User 302.

The User 304 reference window 626 contains details and/or a list of all the references revealed by User 304 to User 302 for proving the authenticity of User 304. Where the references are hyperlinks, User 302 can call out a chain of cascading windows containing cross-references relating to the User 304 or previous reference by clicking on the hyperlinks in each reference window starting from reference window 626. The information in the cascading windows may be entered by User 304 or populated from data in the IMS or web pages from external Internet sources associated with the references entered in a corresponding reference window that is similar to the User 302 reference window 622 appearing on the computer display of User 304.

The User 304 product/service reference window 628 contains details and/or a list of all the references revealed by User 304 to User 302 for proving the authenticity of the products and/or service User 304 is providing. User 302 can call out a chain of cascading windows by clicking on the hyperlinks in each reference window containing cross-references relating to the products and/or service User 304 possesses or is providing. The information in the cascading windows may be entered by User 304 or populated from data in the IMS or web pages from external Internet sources associated with the references entered in a corresponding reference window that is similar to the User 302 reference window 624 appearing on the computer display of User 304.

The IMS (108 in FIG. 1) may be employed in the following example scenarios.

### Scenario 1

A seller cum designer of handbag has information consisting of pictures and description of a handbag product, which contains special features. She has a user account with the IMS. One reason not to place information of the handbag in the public is that she is afraid that others will start copying the design, which she has not acquired intellectual property protection for. She also only wants someone who has the specific needs for the special feature of her handbag to purchase it. Hence, she enters and saves the information of the handbag in IMS under a suitable confidentiality level selected by her and enables the automatic link-up feature of the IMS.

The buyer of the handbag on the other hand does not have time to look for a handbag with the special features, which the seller's handbag has. She is also afraid that she might buy a counterfeit handbag or be swarmed by irrelevant sellers after broadcasting her intention to buy a handbag with such features. Hence, the buyer, who also has a user account with the IMS, enters and saves her intention of buying a handbag with the special feature in IMS under a suitable confidentiality level selected by her.

The IMS automatically notices a match in the information and alerts the seller to the buyer and vice versa on the next instance the seller or buyer logins to the IMS to link both parties up. To ensure the seller is not a cheat, the buyer reviews the seller's revealed credentials/accreditation (e.g. window 306 in FIG. 3) and the trustworthiness rating of the seller and the seller's posted information that is appended by the IMS. The seller similarly can check the buyer's trustworthiness through the same means. Negotiation on the sale of the product is through email and messaging interfaces (e.g. windows 304, 310 in FIG. 3), which is provided by the IMS at the seller and buyer end.

### Scenario 2

An individual is looking for an ideal job. She is very senior in her current job and does not want many people to know that she is looking around. She also does not want to end up having a job not fulfilling her requirements. Hence, the individual having a user account with the IMS enters and saves her job criteria in IMS under a suitable confidentiality level selected by her. As she understands that her criteria may be a too demanding, she also sets the information matching percentage for her job criteria to 80%. Therefore so long the other party can offer 80% of what she seeks, she will want to consider the other party's offer. She then enables the automatic link up feature of the IMS.

A company is looking for a highly qualified senior person and knows that the headhunters tend to only specialise in certain sectors. Putting an advertisement in the papers at large has not been effective and is costly. Also, as the corporation is world renown, each advertisement attracts enormous amounts of candidates and it is very costly to screen the candidates one by one. Hence, the corporation having a user account with the IMS uses the search function of the IMS to search for the ideal candidate by entering the description of the ideal candidate as search parameters. No search results turned up initially until a month later when the above-mentioned individual logins to enter her job criteria.

When the match in job criteria has occurred, the IMS alerts both parties. The name of both parties need not be revealed if they have decided to keep that confidential. The only indication is the highlighting of the matched information at both parties' end and a hyperlink for the parties to link to each other.

After linking up, both the individual and the corporation verifies and assesses the authenticity of each other's identities through the reference revealed by both parties. Once the basic trust is established, confidential information can be revealed level by level by both parties by expressing each other's request through the negotiation platform of the IMS. Negotiation to employment can be done through the email and messaging interfaces (e.g. windows 304, 310 in FIG. 3), which is provided by the IMS at the individual and corporation end. The exchanges in the emails and messaging interfaces can be offline where each party checks each other's emails or messages at their own leisure time, or in real time if both parties are login to the IMS at the same time.

It is appreciated that besides email and messages, the IMS can provide means for an online meeting between the corporation/seller and the individual/buyer in the above scenarios through Internet telephony or video conferencing.

The IMS described in the example embodiment is a computer system 600, schematically shown in FIG. 7.

The procedures executed by the IMS may be implemented as software, such as a computer program being executed within the computer system (which can be a palmtop, mobile phone, desktop computer, laptop or the like) 700, and instructing the computer system 700 to conduct the method of the example embodiment.

The computer system 700 comprises a computer module 702, input modules such as a keyboard 704 and mouse 706 and a plurality of output devices such as a display 708, and printer 710.

The computer module 702 is connected to a computer network 712 via a suitable transceiver device 714, to enable access to e.g. the Internet or other network systems such as Local Area Network (LAN) or Wide Area Network (WAN).

The computer module 702 in the example includes a processor 718, a Random Access Memory (RAM) 720 and a Read Only Memory (ROM) 722. The computer module 702 also includes a number of Input/Output (I/O) interfaces, for example I/O interface 724 to the display 708 (or where the display is located at a remote location), and I/O interface 726 to the keyboard 704.

The components of the computer module 702 typically communicate via an interconnected bus 728 and in a manner known to the person skilled in the relevant art.

The application program is typically supplied to the user of the computer system 700 encoded on a data storage medium such as a CD-ROM or flash memory device and read utilising a corresponding data storage medium drive of a data storage device 730. The application program is read and controlled in its execution by the processor 718. Intermediate storage of program data maybe accomplished using RAM 720.

Many modifications and other embodiments can be made to the system and its methods by those skilled in the art having the understanding of the above described disclosure together with the drawings. Therefore, it is to be understood that the system and its utility is not to be limited to the above description contained herein only, and that possible modifications are to be included in the claims of the disclosure.

1. A system for identifying and linking users having matching confidential information, the system comprising:
a database for storing user information and data representing reference information for users, the database stores the user information in a manner such that one or more data fields representing at least a portion of the user information are associated with respective confidentiality levels;
a matching engine for identifying matching information in the data fields;
a linking unit for linking two or more users associated with matching information identified by the matching engine; and
a referencing platform for displaying reference information of one user associated with the matching information to another user associated with the matching information, wherein the reference platform provides links to other reference information associated with the reference information displayed for establishing a chain of references for authenticating trustworthiness of the respective users.

2. The system as claimed in claim 1, wherein the linking unit alerts the users associated with the matching information by sending electronic messages to the users.

3. The system as claimed in claim 1, wherein the system further comprises a communication platform for facilitating negotiation between the users.

4. The system as claimed in claim 3, wherein the communication platform comprises one or more of a group consisting of:
an email server;
a messaging application;
an Internet telephony application; and
a video conferencing application.

5. The system as claimed in claim 4, wherein the other reference information comprises reference information stored in the database of the system, reference information stored at an external source, or both.

6. The system as claimed in claim 1, wherein the system further comprises a search platform for user input of search criteria, and the search platform is coupled to the matching engine for identifying information in the data fields matching the search criteria.

7. A method for identifying and linking users having matching confidential information, the method comprising:
storing user information in a database in a manner such that one or more data fields representing at least a portion of user information are associated with respective confidentiality levels;
storing data representing reference information for users in the database;
identifying matching information in the data fields utilising a matching engine; and
linking two or more users associated with matching information identified utilising a linking unit;
displaying in a referencing platform reference information of one user associated with the matching information to another user associated with the matching information; and
establishing a chain of references linking to other reference information associated with the reference information displayed for authenticating trustworthiness of the respective users utilising the reference platform.

8. The method as claimed in claim 7, wherein the method further comprises alerting the users associated with the matching information by utilising the linking unit to send electronic messages to the users.

9. The method as claimed in claim 7, wherein the method further comprises facilitating negotiation between the users utilising a communication platform.

10. The method as claimed in claim 9, wherein the communication platform comprises one or more of a group consisting of:
an email server;
a messaging application;
an Internet telephony application; and
a video conferencing application.

11. The method as claimed claim 7, wherein the other reference information comprises reference information stored in the database of the system, reference information stored at external sources, or both.

12. The method as claimed in claim 7, wherein the method further comprising:
inputting search criteria; and
identifying information in the data fields matching the search criteria utilising the matching engine.

13. A data storage device containing computer readable code means for instructing a computer system to execute a method for identifying and linking users having matching confidential information, the method comprising:
storing user information in a database in a manner such that one or more data fields representing at least a portion of user information are associated with respective confidentiality levels;
storing data representing reference information for users in the database;
identifying matching information in the data fields utilising a matching engine; and
linking two or more users associated with matching information identified utilising a linking unit;
displaying in a referencing platform reference information of one user associated with the matching information to another user associated with the matching information; and
establishing a chain of references linking to other reference information associated with the reference information displayed for authenticating trustworthiness of the respective users utilising the reference platform.
